(19) United States
(12) Patent Application Publication
(10) Pub. No.: US 2010/0223403 A1
(43) Pub. Date: Sep. 2, 2010

(54) INTEGRATED CIRCUIT CARD INTERFACE DEVICE WITH MULTIPLE MODES OF OPERATION

(75) Inventors: Paul W. Chau, Natick, MA (US); Kerry R. Matthew, Clinton, MA (US); Gerry W. Vandenengel, Grafton, MA (US)

Correspondence Address: SHELDON MAK ROSE & ANDERSON PC, 100 Corson Street, Third Floor, PASADENA, CA, 91103-3842, US

(73) Assignee: SPYRUS, INC., San Jose, CA (US)

(21) Appl. No.: 12/756,359

(22) Filed: Apr. 8, 2010

Related U.S. Application Data
(63) Continuation of application No. 09/574,697, filed on May 17, 2000, now abandoned.
Application No. 09/574,697 is a continuation of application No. 09/422,038, filed on Oct. 20, 1999, now abandoned.

(51) Int. Cl. G06F 3/00

(52) U.S. Cl. 710/14

(57) ABSTRACT

An integrated circuit (IC) card interface device with multiple modes of operation allows communications with numerous IC cards, including smart cards. An interface device according to the present invention can be used several different ways, including: connected to a host device (such as a person computer); in a standalone configuration; and as a flexible platform upon which future applications can be based, since it can be easily reprogrammed and upgraded. The interface device can contain an application engine and an I/O module, providing a flexible architecture and allowing several different operating modes. In connected mode, the interface device can, for example, be connected to a PC to enable the use of smart cards in secure applications. In standalone mode, the interface device can provide information about smart cards with which it interfaces. Programming mode enables the host device or the smart card itself to update or upgrade the programs available within the interface device. When being updated or upgraded, the source of the programming can be from a host device or from the smart card, adding further flexibility to the use of such an interface device.

### CROSS-REFERENCE TO RELATED APPLICATIONS

The present application is a continuation of U.S. patent application Ser. No. 09/574,697, filed May 17, 2000; which is a continuation of Ser. No. 09/422,038, filed Oct. 20, 1999; the contents of which are incorporated in this disclosure by reference in their entirety.

### BACKGROUND OF THE INVENTION

1. Field of the Invention

The present invention relates generally to the area of interface devices for sending information to and receiving information from portable data carriers, including integrated circuit (IC) cards. More particularly, the present invention relates to a smart card interface device or terminal which has multiple modes of operation, including, but not limited to, connected mode, standalone mode, and programming mode.

2. Background Information

Existing interface devices for IC cards, including devices commonly known as smart cards, can broadly be categorized into two groups. The first group includes those interface devices intended to be used in a portable or standalone manner. Devices in this group generally have a specific smart card application embedded into the masked read only memory (ROM) of the internal microcontroller, and are generally intended to support a particular set of smart cards. Once a device in this group has been built, the internal application cannot be modified to support any new requirements or new smart cards. The second group includes those devices designed to be generic smart card interface devices that connect to an external host machine, such as a personal computer or an automatic teller machine (ATM). Here, the smart card application would be running in the host machine and the reader would merely be serving as an interface device. Smart card interface devices in this group would not offer any portable or standalone application capabilities.

Other smart card interface devices may be reprogrammable, but do not have multiple modes of operation. For example, U.S. Pat. No. 5,679,945 issued to Renner, et al., discloses an intelligent card reader for allowing communications with devices having several different data formats. However, one of the main purposes of the system according to Renner is to emulate devices other than smart cards. It does not teach multiple modes of operation, nor does it teach how to support such multiple modes via the functional partitioning of the interface device into an application engine in combination with an I/O module. In addition, the system according to Renner does not include authentication of reprogramming information loaded into the reader device.

A smart card interface device that offers flexibility via multiple operating modes is needed. This will enable users to interface with smart card applications contained on a host device, such as a personal computer (PC), as well as enabling standalone operation. In addition, a reprogrammability feature in such an interface device will allow such a device to be updated from any of several sources. Furthermore, a portable version of such an invention would enable an interface device to be used whenever convenient for the user.

### SUMMARY OF THE INVENTION

An IC card interface device with multiple modes of operation can be easily connected to a PC to enable smart card security applications such as secure web browsers, secure e-mail, and on-line electronic cash purchases. In addition, it can be compact enough to be conveniently carried by the user and used in a standalone mode. In this mode it can be used to give users access to information and applications on multiple IC cards, such as security keys, electronic purse balances, phone numbers, appointments, and medical records.

An IC card interface device according to the present invention will overcome the shortcomings of other interface devices, and will provide significant improvements over the current types of smart card readers. Accordingly, an object of this invention is to provide an interface device with multiple modes of operation, including connected mode, standalone mode, and programming mode. Another object of this invention is to provide a smart card reader which supports rapid development of security applications for a wide range of smart cards from a number of different vendors, and to allow multiple smart card applications to be easily combined on a single portable reader. A further object of this invention is to provide a functionally partitioned system architecture that can be adapted to a wide variety of products. Another object of this invention is to allow easy development of standalone or portable smart card applications. This will alleviate the need for a user to have more than one smart card reader. Yet another object of this invention is to allow the development of applications after the interface device has been distributed, which can provide significant advantages over existing interface devices with fixed operations.

### BRIEF DESCRIPTION OF THE DRAWING

FIG. 1 is a physical block diagram of a system which includes an interface device according to the present invention.

FIG. 2 is a high level functional block diagram of a system which includes an interface device according to the present invention.

FIG. 3 is a detailed functional block diagram of a smart card interface device with multiple modes of operation according to the present invention.

FIG. 4 is a block diagram of a multiple mode smart card interface device operating in connected mode.

FIG. 5 is a flow chart depicting the operation of a multiple mode smart card interface device operating in connected mode.

FIG. 6 is a block diagram of a multiple mode smart card interface device operating in standalone mode.

FIG. 7 is a flow chart depicting the operation of a multiple mode smart card interface device operating in standalone mode.

FIG. 8a is a block diagram of a multiple mode smart card interface device operating in programming mode, where the programming originates from the host.

FIG. 8b is a block diagram of a multiple mode smart card interface device operating in programming mode, where the programming originates from the smart card.

FIG. 9 is a flow chart depicting the operation of a multiple mode smart card interface device operating in connected mode.

FIG. 10 is a block diagram showing the physical components in one embodiment of a smart card interface device with multiple modes of operation.

FIG. 11 is a detailed functional block diagram of an application engine.

FIG. 12 is a detailed functional block diagram of an I/O module.

FIG. 13 depicts the general process for developing applications for an interface device with multiple modes of operation.

FIG. 14 is a detailed depiction of the process for developing applications for a smart card interface device with multiple modes of operation.

### DESCRIPTION OF THE PREFERRED EMBODIMENT(S)

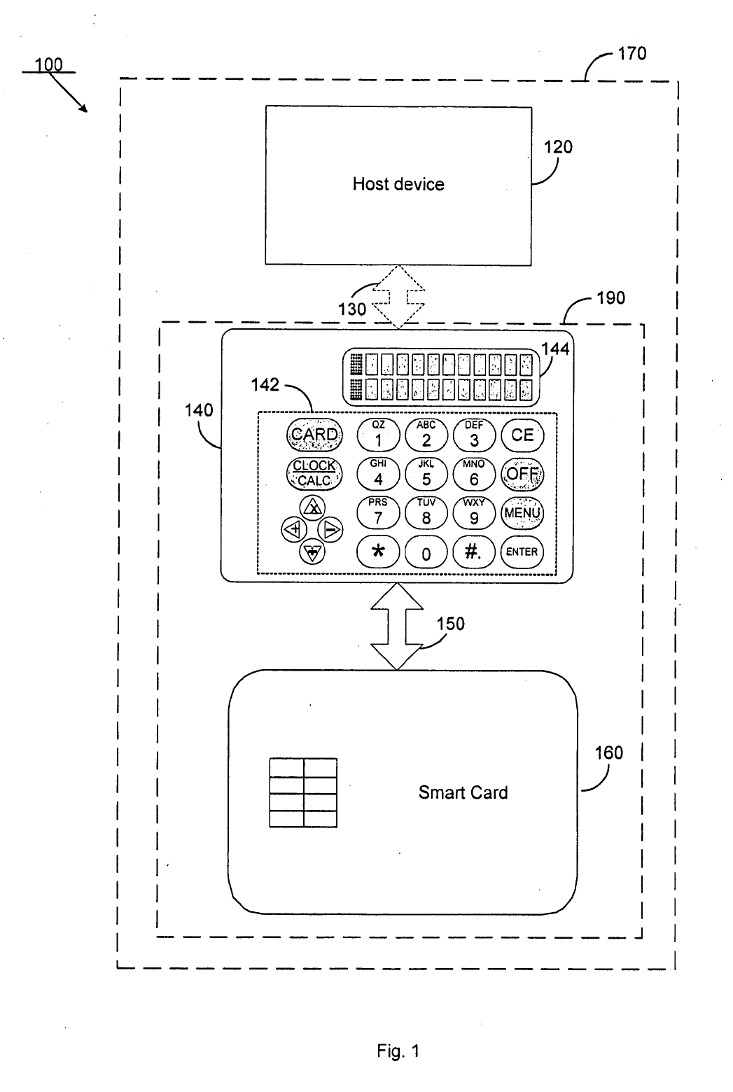

As shown in FIG. 1, an IC card interface device 140 with multiple modes of operation can operate in connected mode 170, whereby it can communicate both with host device 120 (connected via asynchronous communications channel 130) and with smart card 160 (via communications path 150). In addition, interface device 140 can operate in a standalone mode 190, whereby it only communicates with smart card 160. In standalone mode 190, the operation of interface device 140 would be completely self-contained. In general, a mode of operation can be any distinct operating configuration involving interface device 140. In particular, one feature of a mode of operation can be the number of other devices (if any) to which interface device 140 can be connected.

Interface device 140 shown in FIG. 1 can include both a keypad and a display. In one embodiment, interface device 140 can include 20-button membrane switch keypad 142 and liquid crystal display (LCD) 144. In this embodiment, the LCD can have two lines of 12 characters each and each character can be configured as a 5×7 dot matrix, allowing alpha-numeric text messages to be displayed.

The ten numeric keys on 20-button keypad 142 can be used for both number entry and text entry. Text entry of alphabetic characters into a keystroke buffer can be accomplished by having each numbered key mapped to three alphabetic characters. In one embodiment, when a numeric key on 20-button keypad 142 is pressed, it will first register the numeric value of that key. If the same key is pressed again, it will proceed to display the first alphabetic character mapped to that key. Another press of the same key and it will proceed to display the second alphabetic character mapped to the key. Continued key presses on the same key will rotate the displayed character around to the four choices. When the desired character is displayed, the user can press a control key (such as, for example, the right arrow key) to advance to the next character to be entered. The cursor can then shift right to the next position and interface device 140 can wait for the next key input.

In addition to the ten numeric keys, there can be ten control keys on 20-button keypad 142. The control keys can be used for several different purposes, including, for example, power on/off, cursor movement, display scrolling, calculator functions, and for setting the time and date. Control keys can also be used as input for applications.

In a different embodiment, interface device 140 can include a standard (or “QWERTY”) keyboard instead of keypad 142. Likewise, any of several different display devices could be used in place of LCD 144.

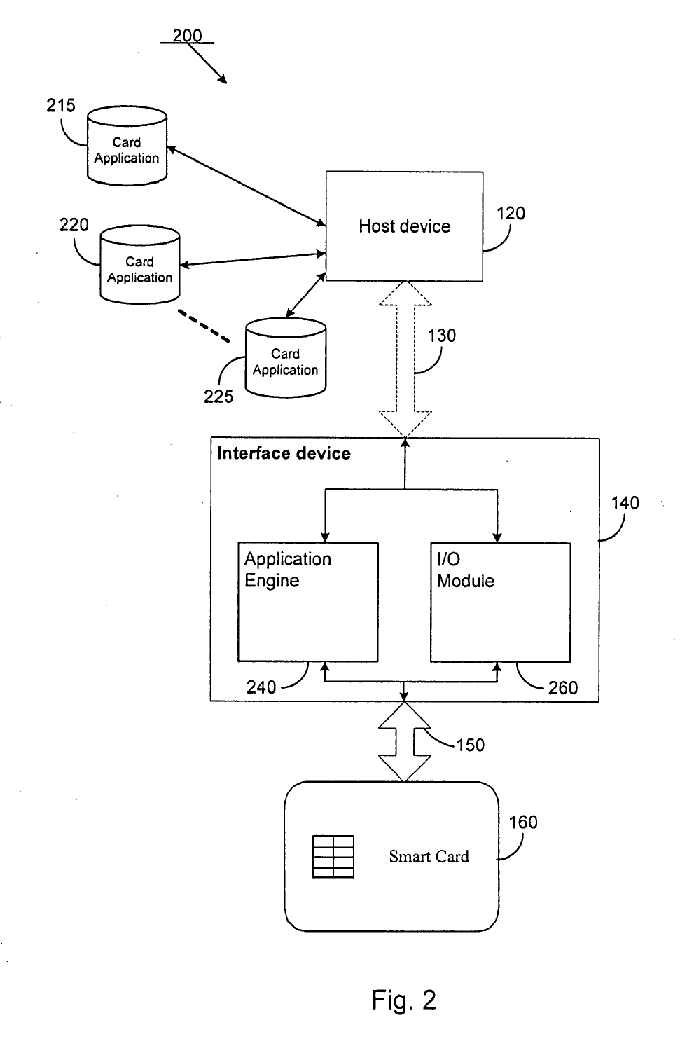

As depicted in FIG. 2, the functionality of interface device 140 according to the present invention can be shared between application engine 240 and input/output (I/O) module 260. Interface device 140 can allow smart card applications running on host device 120 to communicate with smart card 160. As shown in FIG. 2, card application 215 and card application 220 can each execute within host device 120, and can communicate with smart card 160 via interface device 140. The “Interoperability Specification for ICCs and Personal Computer Systems”, version 1.0, December, 1997 (also known as the PC/SC standard), provides detailed information on a standard interface between personal computers and smart cards. A personal computer would be one type of host device 120. In a connected mode of operation, the particular card application being executed could interface with both application engine 240 and I/O module 260 using commands specified in the PC/SC standard.

Card application 225 represents any application that can be developed in the future, but which will operate with interface device 140. For example, card application 225 could be a secure login application developed for a new operating system, allowing interface device 140 to communicate with that new operating system. Card application 225 could also be a home banking application that can be developed by a bank that would allow a user to load funds into an electronic purse on smart card 160 through a connection over the Internet to the bank.

In contrast to smart card applications running on host device 120, interface device 140 can also contain resident applications. A simple calculator can be a resident application in I/O module 260. This application can be under complete control of I/O module 260, and would therefore not; involve any operations of application engine 240.

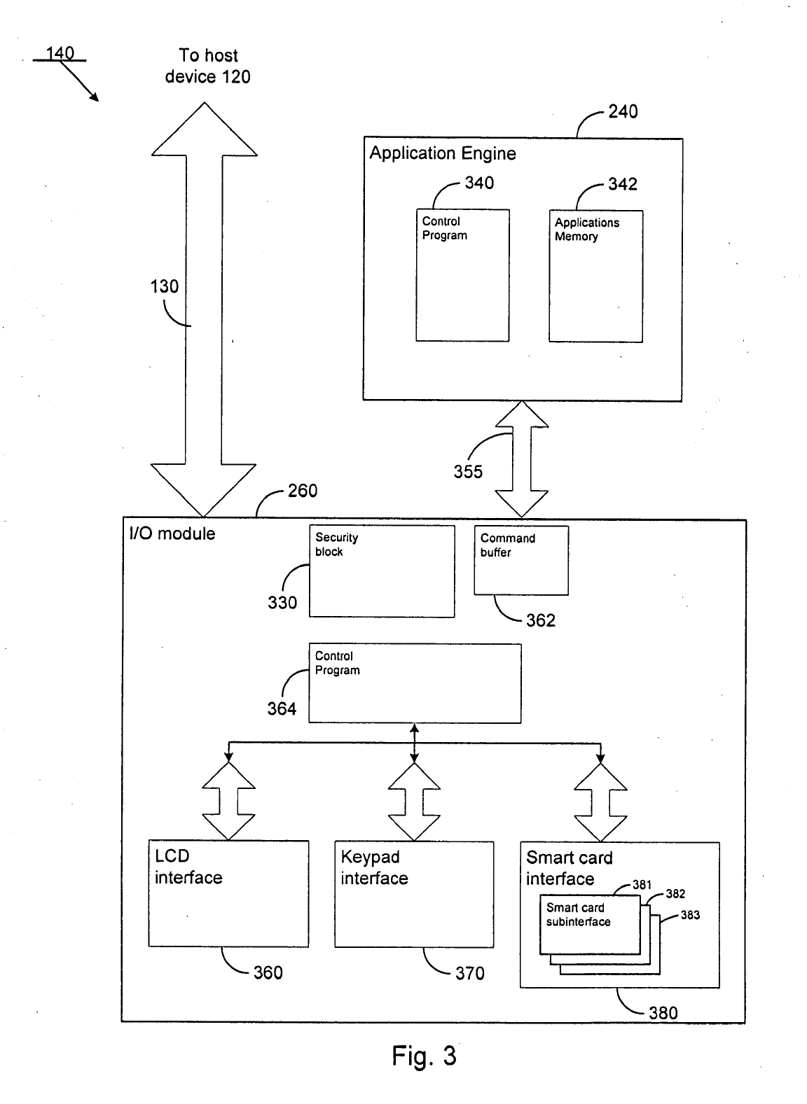

FIG. 3 depicts a functional block diagram of interface device 140. As shown in FIG. 3, interface device 140 can have two distinct external I/O interface channels. The first channel can be for smart card interface 380. Smart card interface 380 can actually consist of one or more interfaces to different smart cards (as indicated by subinterface 381, subinterface 382, and subinterface 383). The second channel can be asynchronous communications channel 130 to external host device 120. I/O module 260 can communicate with host device 120 over this channel. The destination for the data coming from the host depends on the operating mode of interface device 140. If the destination is application engine 240, I/O module 260 can route the data to application engine 240 via communications channel 355.

Application engine 240 can contain application engine control program 340, which can control the operation of the various applications contained in application memory 342. In addition, application engine 240 can communicate with I/O module 260 over communications channel 355. Application engine 240 can further be used to store personalization data, including, for example, a user name, a user pin number, and other kinds of user-related records.

I/O module 260 can contain security block 330, command buffer 362, and I/O control program 364. I/O control program 364 can control the flow of data to and from the various interfaces, such as LCD interface 360, keypad interface 370, and smart card interface 380. In addition, I/O module 260 can control all resident applications including, but not limited to, the clock, the calculator, and the power management functionality.

An interface device according to the present invention can have several modes of operation, including, but not limited to, Standalone mode, Connected mode, and Programming mode. In one embodiment, Standalone mode is the normal operating mode when interface device 140 is not connected to a host device. In this mode, interface device 140 can run smart card applications, (along with resident applications that do not involve the smart card), that are stored in its memory. Connected mode is the normal operating mode when interface device 140 is connected to a host computer. In this mode, interface device 140 is under control of an application program running on the host. Programming mode is used to load new applications in the memory of the interface device, and is a special case of both Standalone mode and Connected mode.

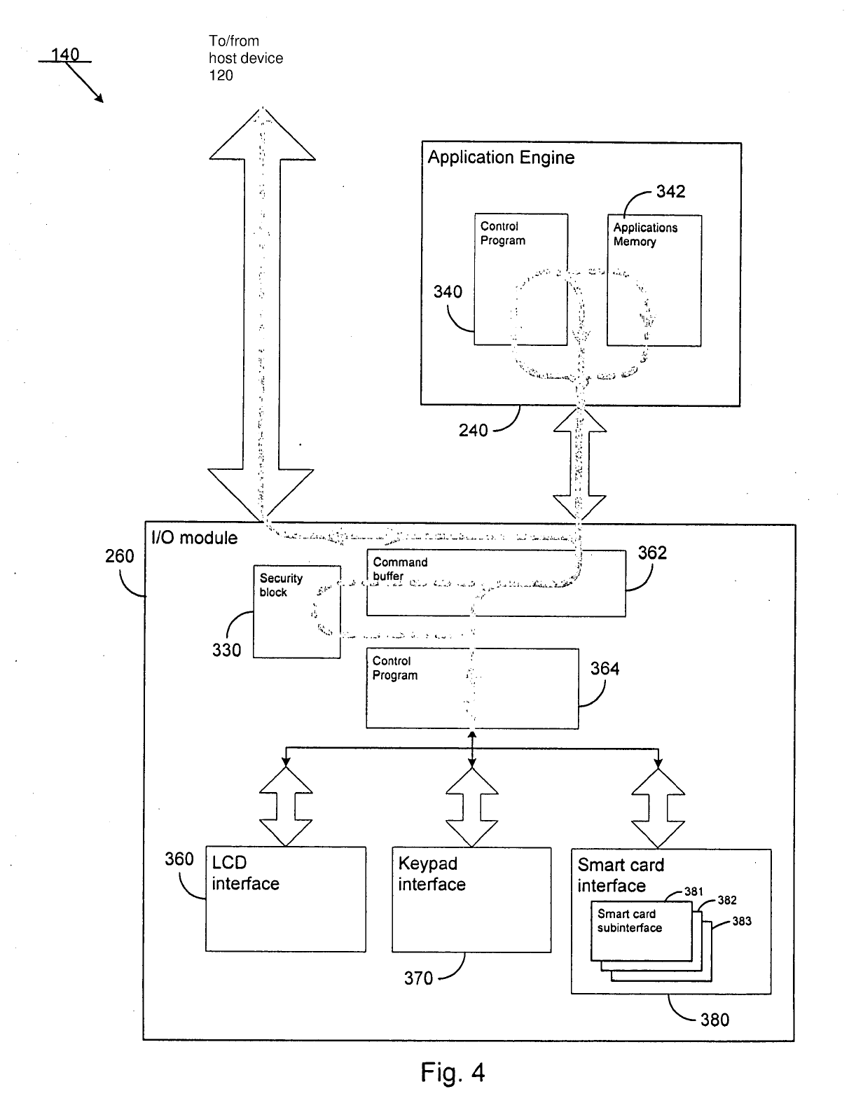

FIG. 4 illustrates Connected mode operation in one embodiment of the present invention. In Connected mode, an application program can run on host device 120 which can communicate with interface device 140. Host device 120 can process several aspects of the ISO 7816-3 protocol, which defines the interface to a smart card device. Consequently, these aspects of the 7816-3 protocol will not be handled by I/O module 260. In Connected mode, I/O module 260 can receive command data from host device 120, and I/O control program 364 can then process the command data. After processing the command data, I/O module 260 can transfer response messages back to host device 120. If necessary, application engine 240 can respond to service requests from I/O module 260.

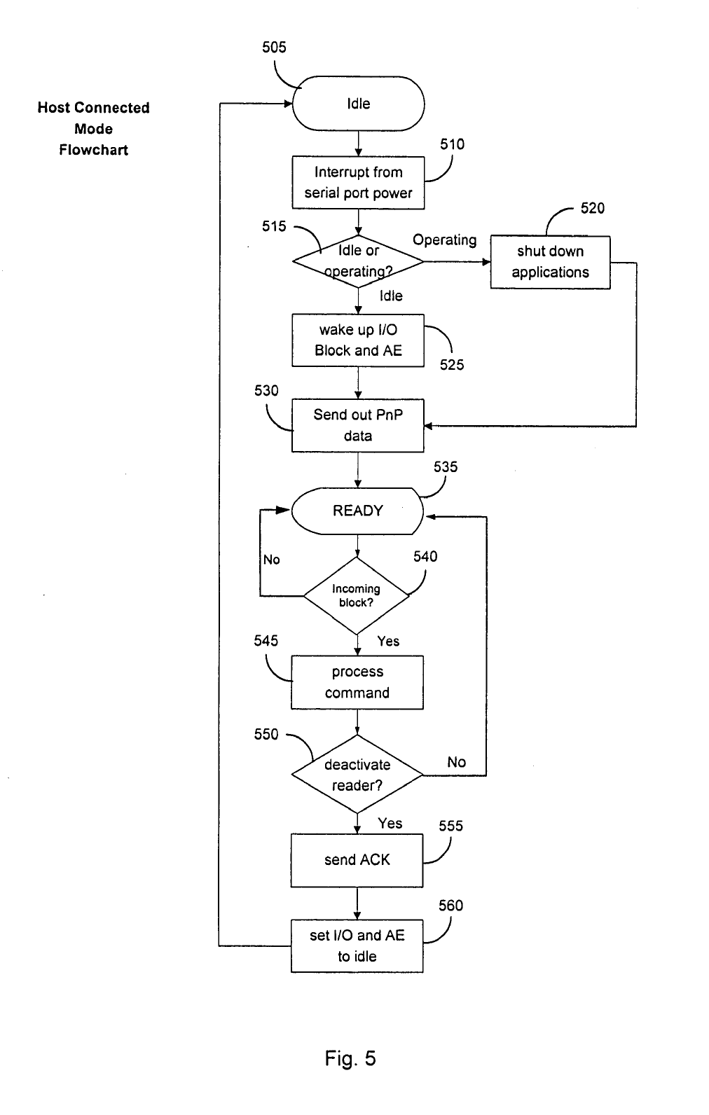

The flowchart in FIG. 5 provides details on the operation of an interface device in Connected mode, according to one embodiment of the present invention. When interface device 140 is in idle state 505, it can respond to an interrupt triggered by a power signal from the connection to the host in step 510. Upon receiving an interrupt in step 510, interface device 140 can first determine in step 515 if it is in idle state or if it is in operational state. If interface device 140 was in idle state when the interrupt was received, I/O module 260 and application engine 240 will be activated in step 525. If interface device 140 was in operating state when the interrupt was received, the application being run will be terminated in step 520.

In step 530, interface device 140 can send out Plug and Play (PnP) data according to the Microsoft PnP standard defined in “Plug and Play ISA Specification 1.0A”, which identifies it to host device 120. This allows the operating system on host device 120 to recognize the arrival of a new device and to load the appropriate software driver to support the new device. Once PnP data has been sent out by I/O module 260 in step 530, interface device 140 will enter the READY state in step 535 where it will wait for an incoming data block. When an incoming data block is detected in 540, control will be passed to step 545 where I/O module 260 will process the command. After processing the command, I/O module 260 can determine in step 550 if interface device 140 is to be deactivated. In Connected mode, deactivation can be accomplished when the host application powers down the reader. The host application can send out a request to deactivate the reader. After the reader acknowledges the request, the host application can shut down the serial port which removes power to the reader. If deactivation is not required, interface device will return to READY state in step 535. If deactivation is required, an acknowledgement signal will be sent to host device 120 in step 555, followed by I/O module 260 and application engine 240 being set to idle in step 560. Once this has occurred, interface device 140 will enter idle state 505.

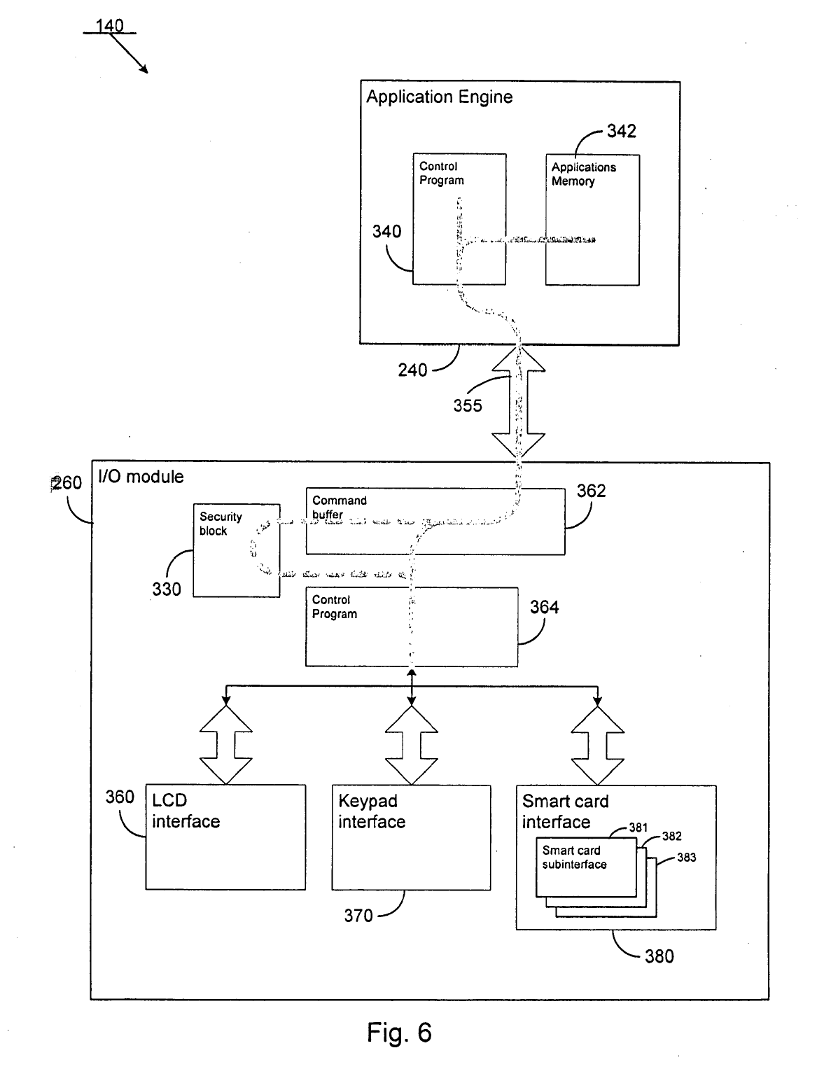

FIG. 6 depicts Standalone mode operation in one embodiment of the present invention. Standalone mode can be used to run applications which are stored in the memory of interface device 140, and which do not require interfacing with a host device. These applications can include both resident applications and user specific smart card applications.

In a standalone mode of operation, several resident applications, including, but not limited to, a real time clock, a battery level monitor, and a calculator can all run independently inside of interface device 140, without needing to be connected to a host device. The resident applications can be stored in the ROM of I/O module 260.

The clock application can be used to view the time or the date, and change them, if necessary. In addition, the clock application can provide an alarm function for the user. A 32 kHz crystal can be used to drive I/O module 260 when in idle state to maintain the clock. The calculator application can provide a simple four-function calculator.

A battery level monitor can use an A/D converter in I/O module 260 to perform a voltage test of the batteries whenever application engine 240 or I/O module 260 are activated by an interrupt key. A “LOW BATTERY” message can be displayed if the battery level is not within acceptable limits.

User specific smart card applications can be added or deleted by the user. Examples of user specific smart card applications can include such things as a program to display electronic purse or cash card balances and transactions, or a program to view phone numbers and access codes stored on a smart card.

As shown in FIG. 6, application engine control program 340 in application engine 240 can control the execution of interface device 140 in Standalone mode. Application engine 240 can send data blocks to I/O module 260 where they will be stored in command buffer 362 and will be processed by I/O control program 364. Depending on the operation being performed, security block 330 of I/O module 260 may also be invoked. For example, during the download of a new interface device application program, security block 330 can be used to check the security of the new program.

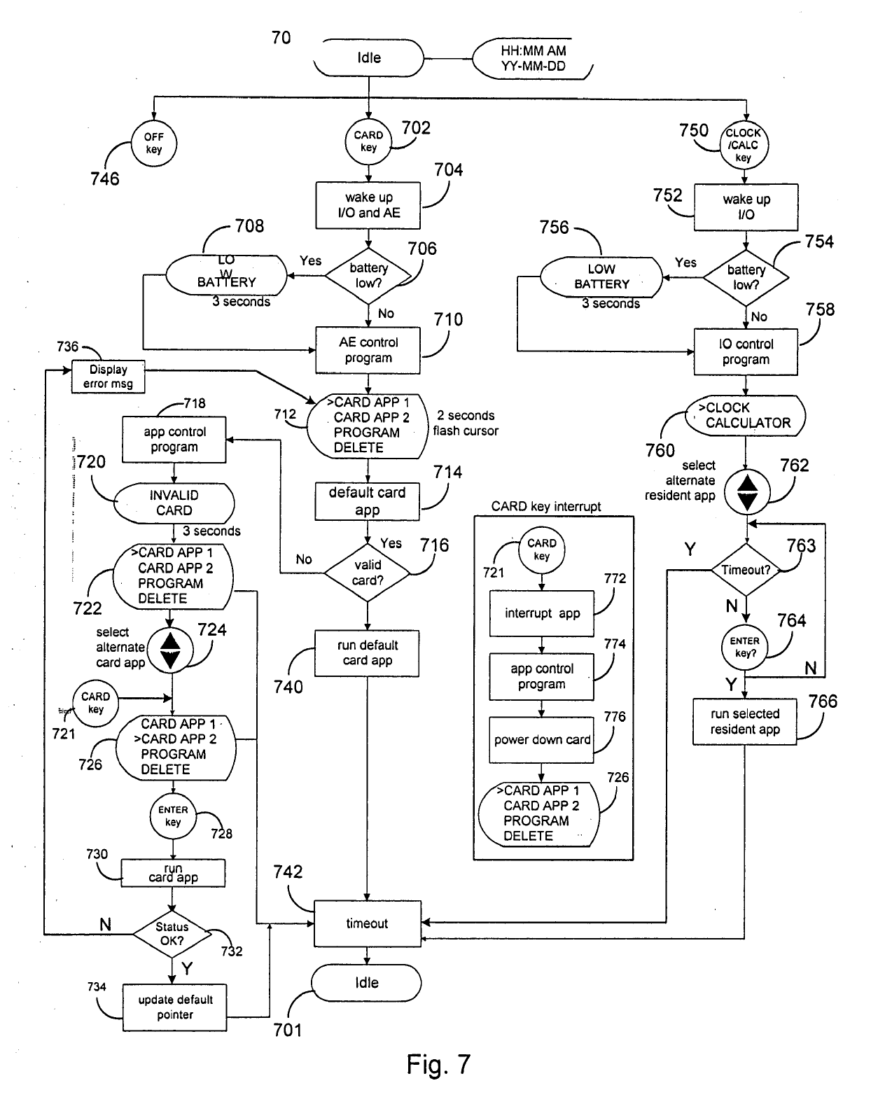

FIG. 7 shows a flowchart for Standalone operation. When interface device 140 is in idle state 701, application engine 240 will be in sleep state and I/O module 260 will be running in idle state. Sleep state refers to a state where all activity in application engine 240 has ceased due to the clock being stopped, and power is lowered. With interface device 140 in idle state 701, I/O module 260 can update the time/date information and can maintain the display. To run any application the user must “wake” up the unit by pressing either the CARD key in step 702 or the CLOCK/CALC key in step 750. Before any applications start, I/O module 260 can run the battery level monitor program to check the battery in step 706 or step 754.

A press of the CLOCK/CALC key at 750 by the user can activate I/O module 260 in step 752 via an interrupt. If I/O module 260 determines in step 754 that the battery has fallen below defined limits, it can display a “BATTERY LOW” warning for three seconds at step 756 before continuing operation. I/O control program 364 can then take control at step 758, and can cause a multiple-line menu to be displayed at 760. This menu could consist of such entries as CLOCK and CALCULATOR. The user can scroll the pointer to the desired line by pressing the up or down arrow buttons at 762 and can press the ENTER key at 764 to activate that application at 766. Interface device 140 can time-out after 30 seconds of inactivity at 742 and return to idle state 701.

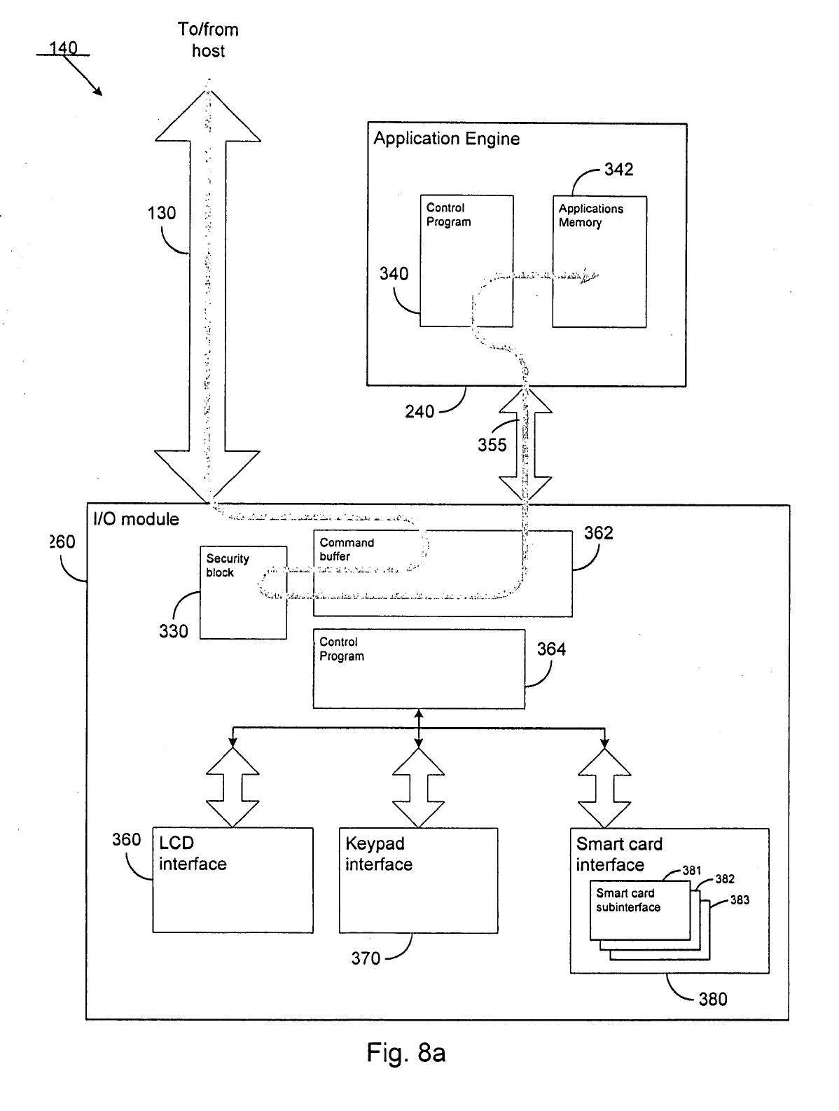

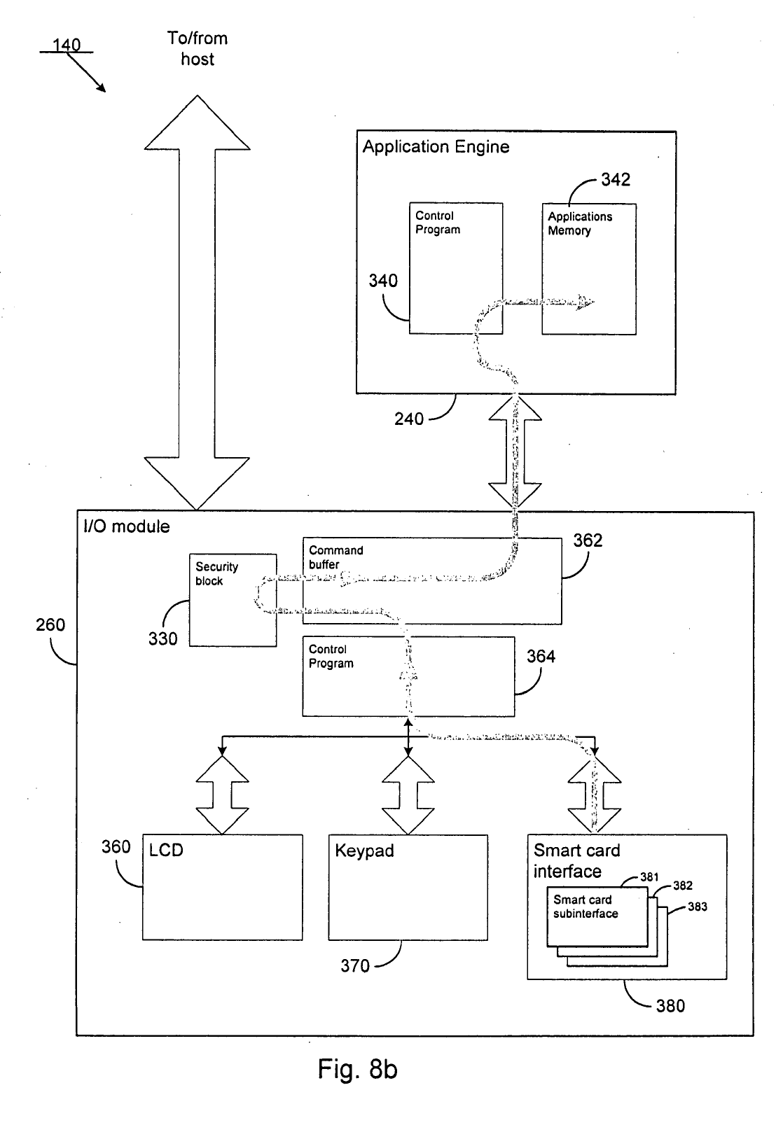

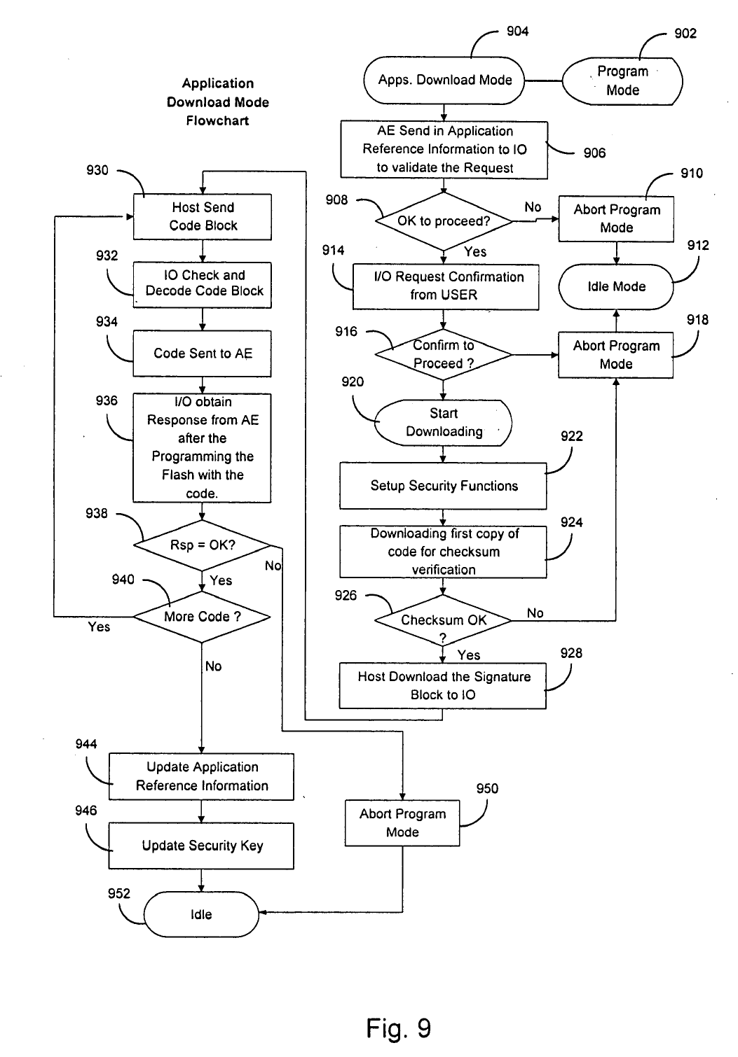

A user can press the CARD key at 702, which can activate both application engine 240 and I/O module 260 through interrupts at step 704 causing both to switch to high speed operation. If I/O module 260 determines in step 706 that the battery has fallen below defined limits, it can display the “BATTERY LOW” warning for three seconds at step 708 before continuing operation. Application engine control program 340 within application engine 240 can send a menu display of card applications to the I/O module in step 710. In one embodiment, all of the card applications can be listed followed by a PROGRAM and DELETE line. As shown in 712, the applications could, for example, be listed as CARD APP 1 and CARD APP 2, followed by PROGRAM and DELETE. The PROGRAM and DELETE entries are used in programming mode only (to be described further with respect to FIG. 8a, FIG. 8b, and FIG. 9).

The first card application listed in the menu can be the default application. The default application can start immediately at step 714. If a determination is made at step 716 that interface device 140 contains a valid smart card, the default card application can run at step 740 and can then timeout after completion in step 742. If the default application does not recognize the card or there is no card present, the default application can terminate, application engine control program 340 can take control at step 718, and application engine 240 can then display an INVALID CARD message for three seconds at step 720 followed by the menu display at step 722. The user may then select an alternative application by scrolling the pointer with the up/down arrow keys at step 724 followed by pressing the CARD key at 721. If an alternative application is selected in 726, the program can be run in step 730. Upon completion, the status of the executed application can be checked in step 732. If the selected application properly completed, the default pointer can be updated in step 734, followed by a timeout in step 742 and return to idle in step 701. If execution of the selected application failed, an error message can be displayed in step 736, followed by a display of the main menu in step 712.

The default program update operation is used to ensure that a single interface device keystroke can be used to run a card application. For instance, if the user normally stores an electronic purse card in interface device 140, the user can quickly read the balance by simply pressing the “CARD” key, with the balance application as the default.

If the user wants to run a different program after the default program has started, the user can press the CARD key in step 721. This can cause the default operation to be interrupted as shown in step 772, at which point application engine control program 340 can take control in step 774. Application engine control program 340 can then power down the smart card in step 776 and display the main menu in step 726.

Programming mode, shown in FIG. 8a and FIG. 8b, are derived from the Connected and Standalone modes discussed previously. Using the program reload functions in Programming mode, a user may install new interface device functionality into application engine 240, or may delete existing functionality. New interface device functionality may be installed from host device 120 over asynchronous communications channel 130 or from smart card 160 via smart card interface 380.

In general, I/O module 260 can control the programming process of interface device 140. In particular, I/O module 260 can establish Programming mode with host device 120 over asynchronous communications channel 130, or with smart card 160 via smart card interface 380. Next, I/O module 260 establishes communications with application engine 240 via communications channel 355 to prepare it for programming. Finally, I/O module 260 transfers the received interface device program data to application engine 240 for loading. In response, application engine 240 can determine a location for the incoming interface device program, load the program into application memory 342, and update the internal application reference information when the programming completes. In host Programming mode, as depicted in more detail in FIG. 8a, host device 120 can serve as the application source, transferring the interface device program directly to I/O module 260 through asynchronous communications channel 130. In host Programming mode, host device 120 can initiate the loading process and can then manage the loading of the interface device programs into the memory of interface device 140. I/O module 260 can display a confirmation message on the programming request and can wait for the user to confirm. Once a confirmation is received, I/O module 260 can activate application engine 240, and can further obtain application reference information (ARI) from application engine 240. The ARI can be forwarded to host device 120 for validation of whether the program loading request is allowed by application engine 240. For example, the host device can confirm whether or not there is enough space for the new program code. If the request successfully validates, security block 330 can begin a security check process on the program code to be sent to interface device 140. After security block 330 has validated the new program code, the program code can then be loaded first into I/O module 260, following which it can be transmitted to application engine 240 for the actual loading to application memory 342. Application engine control program 340 can program application memory 342 one byte at a time. Each byte can be read back for verification. If a byte loads unsuccessfully, that byte can be rewritten with a longer delay interval before verification. Once a whole data block is programmed successfully, application engine 240 can send back an acknowledgement to I/O module 260 to request the next block of program code.

The application running on host device 120 can query application engine 240 for application reference information (ARI) to determine what programs are currently loaded and how much space is available. The user may then delete interface device programs and/or load new interface device programs.

The interface device program data can be interpreted and validated by I/O module 260 in command buffer 362. Basic validity can be checked in any number of ways. Two ways of checking basic validity include, but are not limited to, checking for a valid key, and validating one or more checksums.

Mutual authentication between host device 120 and interface device 140 can be used to check for a valid key. For example, interface device 140 can be preloaded with a public key which can be used during the initiation of host Programming mode to establish communication between interface device 140 and host device 120.

Also, to check for a valid interface device program, I/O module 260 can prefetch the entire set of program instructions, check for proper syntax, and validate the checksums. If these checks pass, I/O module 260 has good assurance that the new code is not corrupted.

Additional security checks can be performed on the data by security block 330. In particular, security block 330 within I/O module 260 can support the application download process by providing the routines for authenticating any newly loaded interface device program. For example, a digital signature can be included with the interface device program that could be checked by security block 330.

Once all security checks have been completed, the interface device program data can then be loaded into application memory 342 in application engine 240 under the control of application engine control program 340. When programs are added or deleted, application engine 240 can update the ARI in EEPROM.

FIG. 8b depicts Programming mode operation when the program is downloaded via smart card interface 380. This mode of operation can be analogized to installing a software program from a diskette onto a personal computer. In this analogy, the smart card can perform a similar function to the diskette (i.e. the smart card would be the source of the new functionality), and interface device 140 can perform a similar function to the personal computer (i.e., it would have the functionality loaded onto it). If interface device 140 enters programming mode and simultaneously detects a smart card in the slot over smart card interface 380, it can check the smart card for interface device programs to be installed. If interface device 140 finds new functionality to be installed, the new interface device program can be loaded from smart card interface 380 by I/O control program 364. Prior to loading the functionality into command buffer 362, security block 330 can check the new functionality for proper operation. Application engine control program 340 can then transfer the new interface device program from command buffer 362 to application memory 342.

FIG. 9 shows a flowchart depicting the operation of interface device 140 while in host program download mode. Upon receiving a command to do so, interface device 140 can enter programming mode in step 904, which can be displayed on the LCD with the “Program Mode” message shown in 902. In step 906, application engine 240 can send application reference information to I/O module 260 to validate the requested download. If the determination is made in step 908 that the request cannot be completed, Programming mode can be aborted in step 910, and interface device 140 can return to idle state in step 912. This could occur, for example, if there is not enough space in application memory 342 for the interface device program to be loaded. If the determination is made in step 908 that the request can be completed, I/O module 260 can request a confirmation from the user in step 914.

If no confirmation is received, as determined in step 916, Programming mode can be aborted in step 918 and interface device 140 can return to idle state in step 912. If confirmation to proceed is received in step 916, the download process can start at step 920. In step 922, security functions in security block 330 of I/O module 260 can be initialized. Next, a first copy of the interface device program code can be downloaded to I/O module 260 in step 924 in order to verify the checksum. If the checksum does not verify in step 926, which can indicate a possible problem with the integrity of the interface device program code or a communication error, Programming mode can be aborted in step 918 and interface device 140 can return to idle state in step 912.

If the checksum does verify in step 926, host device 120 can download a signature block to I/O module 260 in step 928, followed by a code block in step 930. The signature block can then be checked in step 932. Also in step 932, I/O module 260 can further process the code block by, for example, removing any additional communications protocol data. I/O module 260 can then send the code block to application engine 240 in step 934. Application engine 240 can program its memory, and, if successful it can send a response back to I/O module 260. Upon receiving a response in step 936, I/O module 260 can check the response in step 938 and abort Programming mode in step 950 if the response is not OK. After aborting Programming mode in step 950, interface device 140 can return to idle state in step 952.

If the response received by I/O module 260 from application engine 240 in step 938 is OK, and more interface device programming code needs to be loaded as determined in step 940, control can return to step 930. If no more code needs to be loaded, application reference information can be updated in step 944, and a security key can be updated in 946. The security key could be associated with a loaded application which could further be used to provide security checks for application upgrade or removal. For example, if the user wanted to upgrade an existing application in the reader, a determination might need to be made as to whether this would be possible. This determination could be accomplished by, for example, validating the key associated with that application. Finally, interface device 140 can return to idle state in step 952.

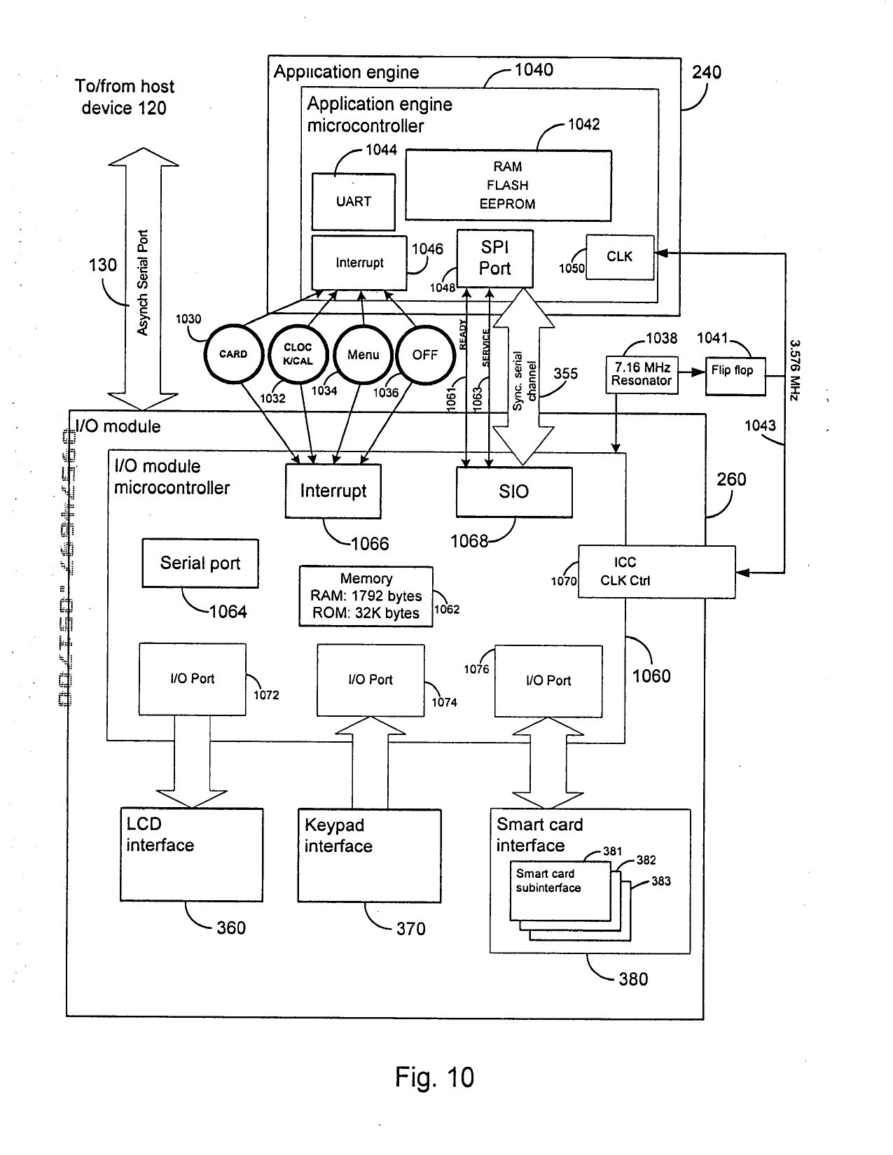

An interface device according to the present invention can include many different functions, including but not limited to application control, I/O services, and host communications. As shown in FIG. 10, these functions can be implemented using separate devices for application engine 240 and I/O module 260. In one embodiment, one or both of the separate hardware devices can be a microcontroller. In another embodiment, one or both of the separate hardware devices can be a custom circuit.

The use of a two device design allows a functional partition of the services of interface device 140. This provides the flexibility of an interface device according to the present invention, and also facilitates the various modes of operation in such an interface device.

In one embodiment, such as Personal Access Reader 2 (PAR 2), designed and manufactured by SPYRUS, Inc., of Santa Clara, Calif., one microcontroller can be used to implement application engine 240 and a different microcontroller can be used to implement I/O module 260. For example, a microcontroller containing flash memory can be used as application engine microcontroller 1040 and can provide the functionality for application engine 240. To support the Programming mode, this type of microcontroller can be serially programmed in-circuit without additional programming voltages. Application engine microcontroller 1040 can include application engine memory 1042, which can contain random access memory (RAM), flash memory, and electrically erasable programmable read only memory (EEPROM). Application engine microcontroller 1040 can also include universal asynchronous receiver and transmitter (UART) 1044, interrupt handler 1046, serial port 1048, and, clock 1050. Interrupt handler can respond to interrupts generated by keys 1030, 1032, 1034, and 1036.

Commands and data from host device 120 can be sent to application engine 240 via I/O module 260. In particular, commands and data transferred from host device 120 on asynchronous communications channel 130 can be received and then processed by I/O module microcontroller 1060. I/O module microcontroller 1060 can include serial port 1064, interrupt handler 1066, serial input/output (SIO) control 1068, ICC clock control 1070, LCD I/O port 1072, keypad I/O port 1074, and smart card I/O port 1076.

If the processing of a command requires the resources (e.g., programs or routines) contained within application engine 240, I/O module microcontroller 1060 can communicate with application engine microcontroller 1040 via communications channel 355.

Also as shown in FIG. 10, I/O module 260 can be implemented with a microcontroller having built-in capability to drive an LCD display, which can be used as I/O module microcontroller 1060. I/O module microcontroller 1060 can include I/O memory 1062, which can contain 1792 bytes of RAM, and 32 kB of read only memory (ROM). I/O module microcontroller 1060 can also include serial input/output (SIO) control 1068 which provides the interface to application engine microcontroller 1040 in application engine 240.

In one embodiment, application engine microcontroller 1040 and I/O module microcontroller 1060 can interface with each other over communications channel 355. This interface can have separate data lines for output (commands) and input (responses). In normal operation, application engine microcontroller 1040 is the master of communications channel 355 and therefore controls the clock. In Programming mode, as discussed previously with respect to FIG. 8a and FIG. 8b, I/O module 260 can act as a device programmer to reprogram application engine microcontroller 1040 with new code from host device 120 or from smart card 160. In this particular mode of operation, application engine microcontroller 1040 is also the master.

To run smart card applications, application engine 240 can control all activity of interface device 140 by issuing PC/SC compatible commands to I/O module 260 over communications channel 355. More particularly, I/O module 260 can support a protocol language based on the PC/SC standard with some enhancement to support the additional Input and Output modules. In addition to implementing a subset of PC/SC standard commands, I/O module 260 can also execute commands that operate directly on the particular hardware of I/O module 260. These hardware-specific commands, though not part of the PC/SC standard, can be consistent with the style of PC/SC commands. This can occur, for example, where commands are needed to handle the display and keyboard of interface device 140. Host device 120 can use this protocol language to gain access to all of the I/O functions provided by I/O module 260. I/O module 260 can respond to any command requests received from application engine 240 over communications channel 355.

I/O module 260 can further support LCD 144 and keypad 142. I/O module 260 can contain other resident applications, such as a real time clock and a calculator.

In addition, I/O module 260 may contain one or more smart card specific applications or algorithms. For example, an electronic purse application could be stored in the ROM of I/O memory 1062 in I/O module 260.

In addition, various aspects of the APDU (Application Protocol Data Unit) level protocol, TPDU (Transport Protocol Data Unit) level protocol, and the T=0 and T=1 smart card protocols defined by ISO 7816 can be shared between application engine 240 and I/O module 260. T=0 refers to a character-oriented asynchronous half duplex transmission protocol, while T=1 refers to a block-oriented asynchronous half duplex transmission protocol.

In one embodiment, a half-duplex interface can be used to link I/O module microcontroller 1060 and application engine microcontroller 1040 together. To keep message synchronization, the interface can employ a handshake signal READY 1061 between application engine 240 and I/O module 260. I/O module 260 can assert this signal to notify application engine 240 when it can transmit or receive a byte. Another interface signal, called SERVICE 1063, can indicate to application engine 240 that I/O module 260 wants to issue an unsolicited status message. For example, I/O module 260 may want to indicate a condition where a smart card has been inserted or removed. When application engine 240 receives this signal, it must clock in the waiting data message.

Since the READY handshake signal is used for data in both directions, the interface must insert a delay when switching from sending to receiving. When application engine 240 wants to send a command to I/O module 260, it can first check to see if I/O module 260 is ready. Once it is ready, application engine 240 can clock out the 8 bits of each character and then delay for a period of 2 bits (stop bits). As soon as I/O module 260 receives a character, it will momentarily de-assert the READY signal while it processes the character. Application engine 240 can then wait for I/O module 260 to be ready again before clocking the next data byte. Once the entire message has been transferred, application engine 240 gets ready to change to message receive mode. Application engine 240 can delay for one character interval to let I/O module 260 have time to switch directions and de-assert the READY signal. After the turn-around delay, application engine 240 can again monitor the READY signal waiting for the first byte of the returned response.

In an alternative embodiment, a full duplex interface can be used to link I/O module microcontroller 1060 and application engine microcontroller 1040 together. When a full-duplex interface is used, the two hand-shaking signals READY and SERVICE can be eliminated.

In one embodiment, clock signal 1039 for I/O module microcontroller 1060 can come from the system clock which can be 7.16 MHz resonator 1038. A clock signal for both application engine microcontroller 1040 and ICC clock control 1070 can also be derived from 7.16 MHz resonator 1038. For example, 7.16 MHz resonator 1038 can be fed through flip-flop 1041 to provide clock signal 1043 for both the AE and the ICC. I/O module microcontroller 1060 can also provide a slower clock from its internal timer output port for use with synchronous memory-based smart cards.

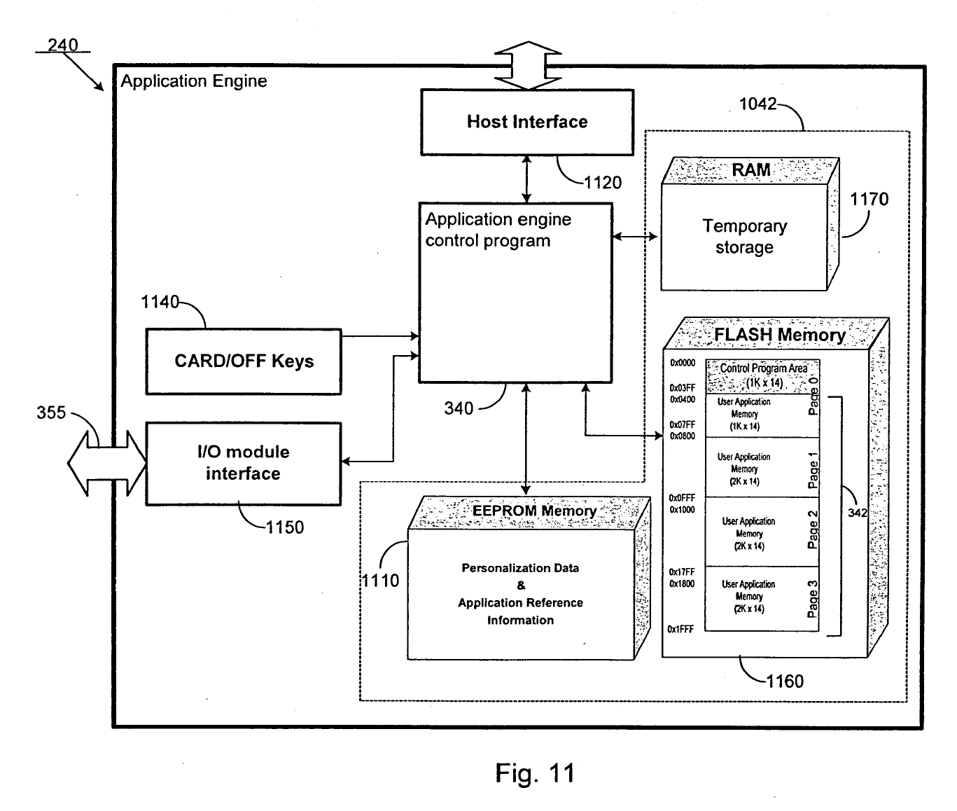

FIG. 11 provides further detail on one embodiment of application engine 240. Application engine 240 can contain application engine control program 340 which provides control over the various resources within application engine 240. These resources can include host interface 1120, I/O module interface 1150, key control 1140, and application engine memory 1042.

Application engine control program 340 within application engine 240 can contain functionality for several different aspects of interface device 140, including but not limited to, communications routines for interfacing with host device 120; synchronous serial communications with I/O module 260; flash programming for application loads; updating of Application Reference Information (ARI); memory compaction (which can include deletion or relocation of application programs in flash memory 1160); and management of user application selections.

In one embodiment, application engine control program 340 can be located within flash memory 1160. The rest of the memory space can then be available for loading interface device programs. Internal applications (i.e., those that have already been loaded) can use the PC/SC protocol language to interface with I/O module 260 for all smart card communications and I/O peripheral support.

In addition to any resident interface device application programs that may have been loaded prior to delivery to the user, one or more interface device programs can be loaded into flash memory of application engine 240 through support of I/O module 260. Since flash memory 1160 in application engine 240 can be incrementally programmed in small sections, an interface device according to the current invention to be upgraded with a new interface device program at any time.

Application engine 240 can further contain support for serial communications with I/O module 260 over communications channel 355. In addition, host interface 1120 provides a communications path to host device 120. Host interface 1120 can, for example, be used by host device 120 to send commands to, and to receive responses back from, smart card 160. Application engine memory 1042 can consist of EEPROM memory 1110, flash memory 1160, and RAM 1170.

In general, RAM 1170 can be used for temporary storage of data by the external applications running on host device 120 which communicate with application engine 240. Flash memory 1160 can be used to store application programs that can be executed on interface device 140. In addition, flash memory 1160 can be programmed from any location, enabling incremental updates to the functionality of interface device 140. EEPROM 1110 may be used to store user information and/or ID information about interface device 140 if required for authentication.

In particular, EEPROM 1110 can store Application Reference Information, including, for example, interface device program descriptions, interface device program start addresses, interface device program size information, and access control information. Access control information can be used to allow application upgrade or removal, by using the access control information to, for example, verify the incoming program data or to authenticate that the reader has the right to download the program to the reader.

Before an interface device program can be loaded into interface device 140, application engine 240 can read the application reference information to determine whether there is enough space for the incoming program. This reference information can also be used in Standalone mode for interface device 140 to manage the execution of the internal programs.

In order to utilize program memory more effectively, EEPROM may also be used to store constants such as APDU message headers according to ISO 7816-4. In addition, EEPROM memory 1110 can contain information such as personalization data. Personalization data can include, but is not limited to, such things as a user name, a PIN, an account number, and a password. In one embodiment, the 8K×14 flash memory 1160 can be divided into four pages, as shown in FIG. 11. Flash memory refers to one type of EEPROM technology that can quickly be programmed and erased electronically. Page 0 of flash memory 1160 can be partitioned into two 1K×14 Blocks. The first 1K×14 of page 0 in flash memory 1160 can be used to store application engine control program 340 and some communications routines. If application engine control program 340 fits within the first 1K×14 of page 0, the second 1K×14 block in page 0 may be used for an interface device application-program. However, this interface device application program may be omitted if application engine control program 340 requires more than 1K of memory.

Page 1 through page 3 in flash memory 1160 are reserved for interface device programs. In one embodiment, interface device programs must start on a page boundary, except for the first 1K interface device program. In addition, all interface device programs should be compiled with an origin at 0x0000. This allows application engine control program 340 to handle all absolute address references, including the addresses needed when “CALL” instructions and “GOTO” routines are executed. Any combination of 2K, 4K, and 6K interface device programs may be configured in flash memory 1160. Interface device programs may be incrementally loaded into program memory without modifying existing programs.

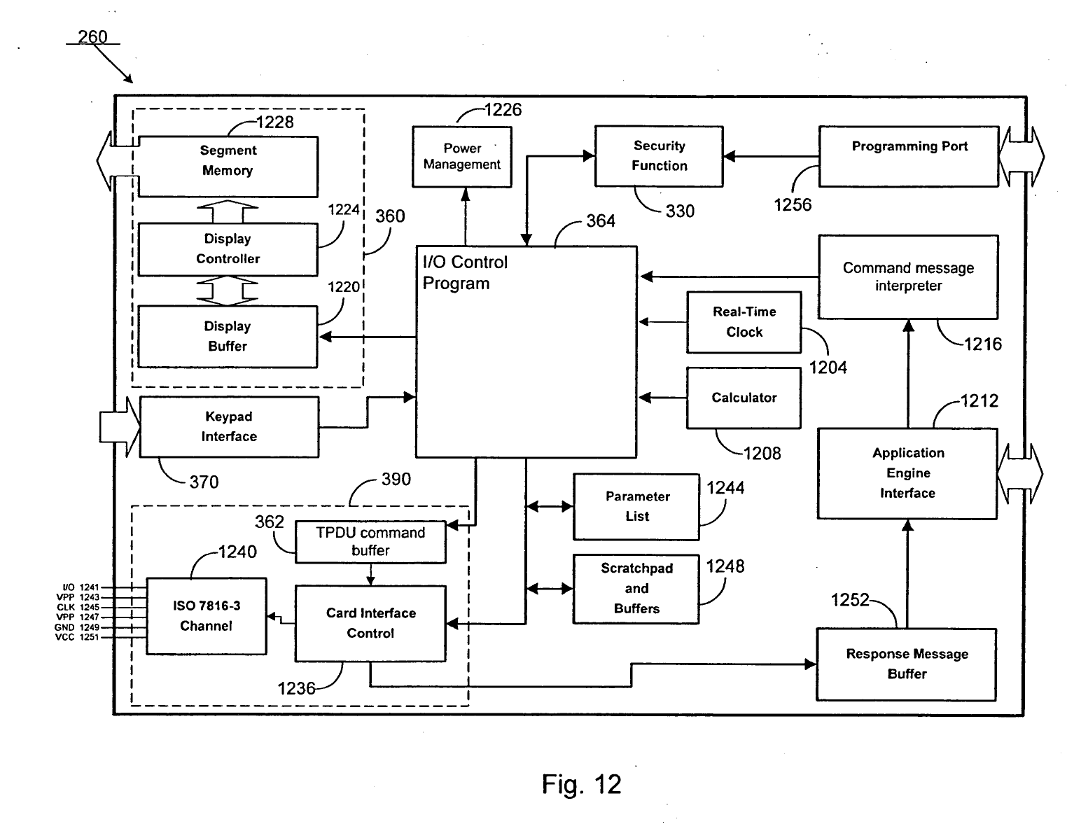

FIG. 12 provides further detail on one embodiment of I/O module 260. I/O control program 364 is the main firmware routine in I/O module 260. I/O control program 364 can generally execute sections of code based on commands from host device 120. I/O control program 364 can also handle other external communications to and from application engine 240 and host device 120, and can handle keypad scanning through interrupts and semaphores.

In addition, I/O control program 364 can manage execution of resident applications, including, for example, the real time clock and the calculator functions. Since an interface device according to the present invention may be a battery-powered device, it can be useful to perform power management to ensure reasonable battery life. However, there may be applications where the interface device can never completely power down. For example, to support the real-time clock, I/O module 260 can run in idle state when interface device 140 is in the “OFF” state. In this state, the clock signal is shut off to most of the peripheral hardware associated with I/O module 260, and to its associated processor core. In one embodiment, both application engine 240 and I/O module 260 are CMOS devices which dissipate almost all of their power during signal transitions. Thus, turning off the clock signals saves substantial battery power. However, the real time clock maintains the clock function for interface device 140. If the user presses the “CLOCK” key, the unit can shift to full high speed state with the main clock signal from application engine 240. If I/O module 260 does not receive any commands after some preset period (e.g. 500 milliseconds), it can enter a high-speed idle state. If application engine 240 sends a command to I/O module 260, it can shift back to full high speed state. I/O module 260 can continue to toggle back and forth between the high-speed idle state and the full high speed state until one of three possible conditions occur. First, application engine 240 can send a command to deactivate interface device 140. Second, a user can press the “OFF” key. Third, a 30-second idle delay maintained by an auto power-off timer can expire. When any one of these three events occurs, application engine 240 can shut down and I/O module 260 can change back to idle state. However, to allow the greatest degree of flexibility, host device 120 can also disable the auto power-off timer.

Application engine interface 1212 can allow communications from I/O module 260 to application engine 240, and can be implemented with an enhanced synchronous serial interface. The enhancement is the addition of two control signals, READY and SERVICE. Within I/O module 260, the data and clock signals can be handled by the Serial I/O Interface (SIO) within I/O module microcontroller 1060. The SIO can be configured as a slave port, requiring an external clock. In one embodiment, application engine 240 can be configured as the master and provide the clock. Data can be transferred in either direction with the least significant bit being sent first, and the master transfers data one byte at a time with at least 2 stop bits between characters.

The SIO can be configured to be in receiving mode as the default state. The SIO indicates that it is available to accept data when the READY line is asserted. When application engine 240 sends a command, the I/O control program 364 can place each byte into a temporary communication buffer. When I/O control program 364 reads each completed byte, it can de-assert the READY signal to indicate a busy status until it is capable of servicing the SIO again. In one embodiment, I/O module 260 can be required to acknowledge every command with a return message. To obtain the acknowledgment, application engine 240 can switch to receive mode after a delay, and can then begin to poll the READY line. When application engine interface 1212 has placed a byte in the SIO staging register (SBUF) in I/O module microcontroller 1060, application engine interface 1212 can assert READY to indicate to application engine 240 that clocking can begin. Application engine 240 can clock the eight bits in to application engine interface 1212 in I/O module 260, and can then wait for the READY signal to be de-asserted before continuing. The SIO on I/O module microcontroller 1060 produces an interrupt for every eight-bit transfer in either direction.

There are situations in which I/O module 260 may need to inform the application running on host device 120 of a real-time event. An example of such an event can be the insertion or removal of a smart card from interface device 140. Application engine 240 is the communication master; therefore I/O module 260 cannot send a message to application engine 240 indicating the insertion or removal of the card if application engine 240 is not expecting such a message. Instead, in these situations, I/O module 260 can assert the SERVICE signal. This signal can indicate to application engine 240 that I/O module 260 has an asynchronous status message to deliver. Application engine 240 can then read the status message directly without explicitly requesting status from I/O module 260. If application engine 240 is in the process of reading a message from I/O module 260 when the asynchronous event occurs, the read of that first message can complete before I/O module 260 issues the SERVICE signal.

Command message interpreter (CMI) 1216 parses commands received from application engine 240 and translates them into discrete signals for I/O control program 364. All messages are prefaced with a header byte, which determines the action which can be taken by I/O module 260.

In one embodiment, only two commands contain card Transmission Protocol Data Unit (TPDU) messages, SendRdrBlock, and Escape. Per ISO 7816-4, TPDU messages consist of a 4-byte header field and a data field with 1 or more bytes. ISO 7816-4 allows data fields in TPDU message to be as large as 256 bytes.

Smart card interface 380 can consist of TPDU command buffer 362, card interface control 1236, and ISO 7816-3 channel 1240. The physical interface to the smart card over ISO 7816-3 channel 1240 consists of six signals as defined by ISO 7816-3, including I/O 1241, VPP 1243, CLK 1245, RST 1247, GND 1249, and VCC 1251. Two additional contact pins on smart card 160 not defined by ISO 7816-3 can be implemented as control lines for certain disposable smart cards. A transistor switch, controlled by a port pin, provides VCC 1251. CLK 1245 can be implemented with the output of a timer from I/O module microcontroller 1060 or with a clock signal (including, but not limited to a 3.579 MHz signal) that can be derived from 7.16 MHz resonator 1038. Selection between the two clock sources can be controlled by using logic gates and port pin from the I/O module microcontroller 1060. I/O 1241 and RST 1247 utilize general-purpose port pins with firmware control. VPP 1247 is normally not connected. Low level communication can be performed using standard routines for receiving and transmitting data, and card interface control 1236 can detect card time-out. I/O control program 364 can call these routines for handling data and for handling time-out conditions. When doing so, the parameters controlling low level timing can be recovered from parameter list 1244.

When an application sends a command to interface device 140 that would cause smart card 160 to be energized (i.e. powered up), I/O control program 364 can first check to make sure that the card slot is full and then energize the card. If the Disable Sync Detect bit (which can be located within card interface control 1236) is cleared, I/O control program 364 will first attempt to determine if a synchronous card is in the slot by clocking the first two bytes. If the first two bytes appear to be valid bytes, the receipt of the command can be acknowledged and the slot can be marked as synchronous. If the first two bytes are not valid data, (e.g. if the bits in both bytes are all is or all 1s or all 0s), the assumption can be made that the card is a microcontroller-based (i.e. asynchronous) card. In this case, I/O control program 364 can then try an internal reset, an active low reset, and additional warm reset cycles to obtain an answer-to-reset (ATR) from the card. If a time-out condition occurs, the response to the invalid command can be a non-acknowledgement (NACK). If I/O control program 364 obtains invalid ATR bytes after the warm reset cycle, the card power can be cycled on and off and the ATR can be retried as a self-clocked card running at 9600 baud. If this does not result in the return of valid ATR bytes, the response to the command can be a NACK.

Command buffer 362 can be the physical storage for the commands to be sent to smart card 160. Generally, this data is volatile since room is required for the return data from the card. However, the TPDU command itself needs to be preserved since information within it is required for managing the returned data. For example, the Le byte of the TPDU command indicates what amount of data is expected in the TPDU response. Thus, the TPDU command can be stored in, for example, a scratch pad or a buffer in the internal RAM.

Smart card data and I/O module status can be loaded in response message buffer (RMB) 1252 for transmission back to application engine 240. Additional information (such as wrapper bytes) can be used to further enhance the data transfer between I/O module 260 and application engine 240. These wrapper bytes can also be loaded into RMB 1252. I/O control program 364 can normally load response message buffer 1252 unless the data is from a smart card. If the destination for the data is the smart card (e.g., in response to a smart card command) then I/O control program 364 only needs to add the appropriate header and wrapper bytes before sending out the data. If the destination for the data is another resource (e.g. the LCD data or keypad) then I/O control program 364 may need to transfer the information to the response message buffer from the other source prior to adding in the appropriate header and wrapper information. If a problem occurs with any card command or response data that I/O module 260 can detect, such as a parity or an error detection code (EDC) error, I/O module 260 will attempt to correct the problem. If the error cannot be corrected, I/O control program 364 can reply to the command with a NACK. In Connected mode, the NACK will be sent to host device 120. In Standalone mode, the NACK will be sent to application engine 240.

I/O module 260 reserves RAM storage for information about smart card 160, including but not limited to, unit type code, capabilities, card communication parameters, and operational status information. I/O module 260 will automatically set card parameters based on the initial answer to reset (ATR), as defined in ISO 7816. This can allow the application running on host device 120 to query such things as type, capabilities, card parameter, and status information about smart card 160. If needed, the application running on host device 120 has the option of varying some of the card parameters from their default values. Examples of parameters that can be adjusted include but are not limited to extra guardtime (N), working wait time integer (CWT for T=0), character waiting time integer (CWI), and block waiting time integer (BWI).

An interface device according to the present invention can support a 4×5-matrix keypad 142 via keypad interface 370 in I/O module 260. If application engine 240 requests key input, I/O module 260 can poll the keypad port via keypad interface 370. Otherwise, the keypad remains monitored via interrupts. The CARD key and OFF key drive interrupts on application engine 240. The CLOCK/CALC key drives an interrupt on I/O module 260 to start the resident applications.

An interface device according to the present invention can also support a two-line, 24-character LCD (12 characters/line) visible display via LCD interface 360 in I/O module 260. LCD interface 360 can includes a four-line by 20 character display buffer 1220. Display controller 1224 can provide conversion between binary representation and ASCII representation; as well as conversion between BCD representation and ASCII representation if requested.

For resident applications scrolling can be controlled by I/O module 260. Scrolling can be controlled by application engine 240 for card applications. If the application supports scrolling, application engine 240 will wait for user arrow key input to update the display buffer pointer in I/O module 260. In Connected mode operation the display is under host control.

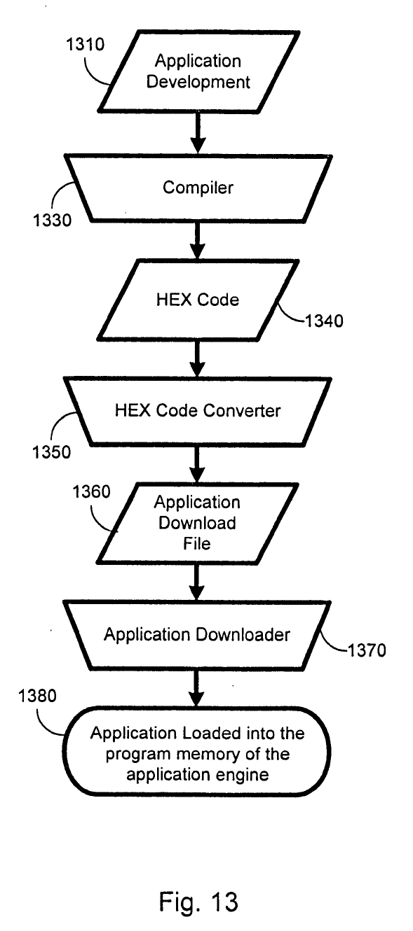

FIG. 13 depicts the application development process that an application developer can generally use to create new programs for use within an interface device according to the present invention. In 1310, the application developer can write program source code. For example, the application developer could write source code for an electronic commerce application in the well known C programming language. This application source code can then be compiled by a commercially available C compiler in 1320, which would compile the application source code from 1310 with interface library functions from 1330. These interface library functions can provide the necessary software routines which allow the application developer to utilize particular resources available within interface device 140.

The compilation of the application source code and the library functions in 1330 can result in a hexadecimal (or hex) code file being produced, as shown in 1340. The hex code file from 1340 can then be converted in 1350 to an application download file 1360 that can actually be loaded into interface device 140. Application download file 1360 can then be downloaded into interface device 140 using application downloader 1370. Application downloader 1370 is a program running in host device 120 that manages the downloading of application download file 1360 to interface device 140. Application downloader 1370 can take application download file 1360 as input, separate that file into smaller segments, and send those segments to interface device 140. This can result in the new application being present in interface device 140. In particular, the new application can be loaded into the program memory of the application engine as shown in 1380.

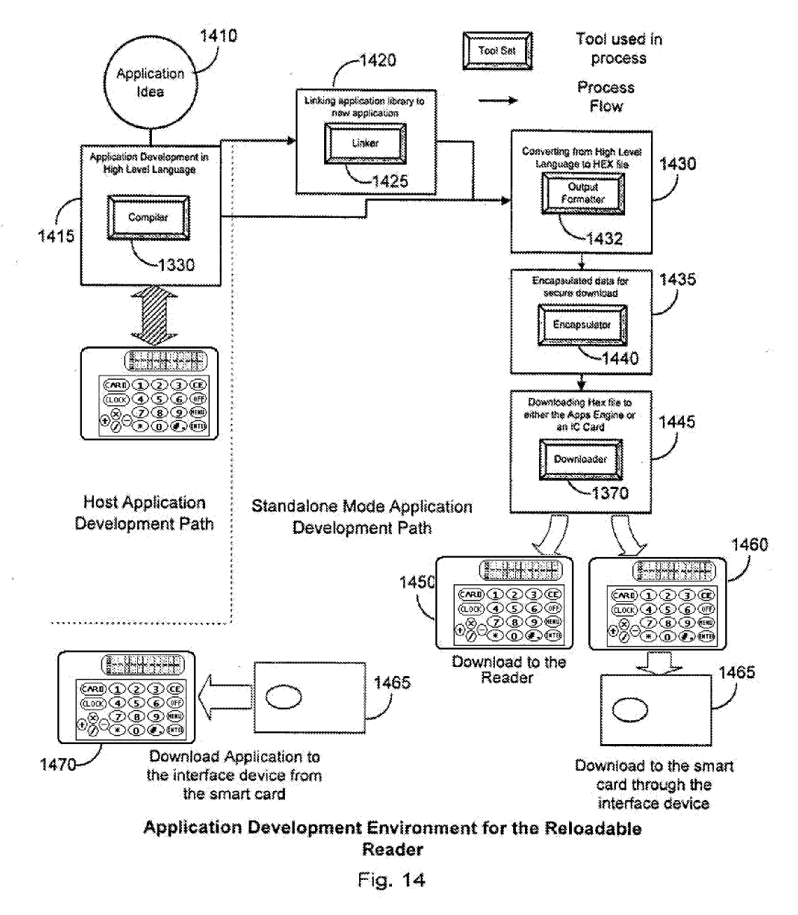

FIG. 14 provides further detail on the application development process described with respect to FIG. 13. The process shown in FIG. 14 expands on FIG. 13 by depicting the various paths by which an application could be developed and loaded into an interface device according to the present invention. FIG. 14 also shows how this process could be used to proliferate applications amongst many different cards and readers.

In step 1410, an application can be developed in, for example, a high level computer language. Once completed, the application can be compiled using compiler 1330. The output of the compiler can then be combined with an application library in step 1420 using linker 1425. Following the linking process, the application can be converted into a particular output format in step 1430, such as a hexadecimal file, using output formatter 1432. For example, an output formatter could convert the output from linker 1425 into hexadecimal format. Once converted, encapsulator 1440 can be used to encapsulate the data in step 1445 as needed for the download process. In this context, encapsulate refers to the further processing of the data to be downloaded into a specific format that would be compatible with the particular download device. Finally, application downloader 1370 can be used to actually download the application to the particular interface device. In this example, the application could be downloaded as an interface device program to interface device 1450. Alternatively, the application could be downloaded as a smart card application to interface device 1460 and then loaded into smart card 1465. From there, smart card 1465 could then further propagate the application by downloading it to interface device 1470.

It is clear that various changes and modifications may be made to the embodiments which have been described, more specifically by substituting equivalent technical means, without departing from the spirit and scope of the invention. The embodiments presented are illustrative. They are not intended to limit the invention to the specific embodiments described and shown in the attached figures. Instead, the invention is defined by the following claims.

What is claimed is:

1. An integrated circuit card interface device comprising:
an application memory;
an application engine for managing one or more applications in said application memory;
an input/output module;
a host interface;
one or more integrated circuit card interfaces; and
an internal power supply;
wherein the interface device is adapted to enable operation in accordance with multiple modes of operation comprising
a standalone mode of operation in which the interface device is not operably connected to a any host device via the host interface, and
a reprogramming mode of operation, in which the interface device is operably connected to an integrated circuit card via one of the one or more integrated circuit card interfaces, and/or to a host device via the host interface, to enable one or more programs to be added to, modified in, or deleted from, the interface device.

2. The integrated circuit card interface device of claim 1, wherein said application memory further comprises a read-only memory.

3. The integrated circuit card interface device of claim 1, wherein said application memory further comprises an electrically erasable programmable read-only memory.

4. The integrated circuit card interface device of claim 1, wherein said application engine further comprises a microcontroller.

5. The integrated circuit card interface device of claim 4, wherein said microcontroller further comprises said application memory.

6. The integrated circuit card interface device of claim 1, wherein said input/output module comprises a microcontroller.

7. The integrated circuit card interface device of claim 1, wherein said application engine further comprises a custom circuit.

8. The integrated circuit card interface device of claim 7, wherein said custom circuit further comprises said application memory.

9. The integrated circuit card interface device of claim 1, wherein said input/output module further comprises a custom circuit.

10. The integrated circuit card interface device of claim 1, wherein the interface device is portable.

11. The integrated circuit card interface device of claim 1, wherein the standalone mode of operation comprises a mode of operation in which the interface device is operably connected to an integrated circuit card via one of the one or more integrated circuit card interfaces to enable communication between the interface device and the integrated circuit card.

12. The integrated circuit card interface device of claim 11, wherein the standalone mode of operation further comprises a mode of operation in which the interface device is not operably connected to another device to enable communication therebetween.

13. The integrated circuit card interface device of claim 12, wherein the multiple modes of operation further comprise a connected mode of operation in which the interface device is operably connected to a host device via the host interface to enable communication between the interface device and the host device.

14. The integrated circuit card interface device of claim 13, wherein during the connected mode of operation the interface device is also operably connected to an integrated circuit card via one of the one or more integrated circuit card interfaces to enable communication between the interface device and the integrated circuit card.

15. The integrated circuit card interface device of claim 11, wherein the multiple modes of operation further comprise a mode of operation in which the interface device is operably connected to a host device via the host interface to enable communication between the interface device and the host device.

16. The integrated circuit card interface device of claim 1, wherein during the connected mode of operation the interface device is also operably connected to an integrated circuit card via one of the one or more integrated circuit card interfaces to enable communication between the interface device and the integrated circuit card.

17. The integrated circuit card interface device of claim 1, wherein the standalone mode of operation comprises a mode of operation in which the interface device is not operably connected to another device to enable communication therebetween.

18. The integrated circuit card interface device of claim 17, where the multiple modes of operation further comprise a connected mode of operation in which the interface device is operably connected to a host device via the host interface to enable communication between the interface device and the host device.

19. The integrated circuit card interface device of claim 18, wherein during the connected mode of operation the interface device is also operably connected to an integrated circuit card via one of the one or more integrated circuit card interfaces to enable communication between the interface device and the integrated circuit card.

20. The integrated circuit card interface device of claim 1, wherein the multiple modes of operation further comprise a connected mode of operation in which the interface device is operable connected to a host device via the host interface to enable communication between the interface device and the host device.

21. The integrated circuit card interface device of claim 20, wherein during the connected mode of operation the interface device is also operably connected to an integrated circuit card via one of the one or more integrated circuit card interfaces to enable communication between the interface device and the integrated circuit card.

22. The integrated circuit card interface device of claim 1, further comprising:
a display unit; and
an input unit.

23. A portable integrated circuit card interface device, comprising:
an application memory;
an application engine for managing one or more applications in said application memory;
an input/output module;
a host interface;
one or more integrated circuit card interfaces;
means for operation without external power;
means for a standalone mode of operation in which the interface device is not operably connected to a host device via the host interface, and
means for a reprogramming mode of operation for adding, modifying, or deleting programs from the interface device.

24. The integrated circuit card interface device of claim 23, wherein the one or more programs are subject to security verification.

25. The integrated circuit card interface device of claim 23, wherein the interface device is operable while being carried by a user.
